(19) United States
(12) Patent Application Publication
(10) Pub. No.: US 2022/0303611 A1
(43) Pub. Date: Sep. 22, 2022

(54) Setting Up a Connection Between a First Application on a First Device and a Second Application on a Second Device

(71) Applicant: Institut Fur Rundfunktechnik GMBH, Munchen (DE)

(72) Inventors: Michael Probst, Munchen (DE); Klaus Merkel, Munchen (DE); Christoph Ziegler, Munchen (DE)

(21) Appl. No.: 17/639,437

(22) PCT Filed: Jul. 20, 2020
(86) PCT No.: PCT/EP2020/070413

§ 371 Date: Mar. 1, 2022

(30) Foreign Application Priority Data
Sep. 2, 2019 (EP) EP19194998

(51) Int. Cl. H04N 21/436; H04N 21/41; H04N 21/81; H04N 21/472

(52) U.S. Cl. CPC H04N 21/436; H04N 21/4126; H04N 21/8173; H04N 21/472

(57) ABSTRACT

A method includes setting up a connection between a first application on a first device and a communication service on the first device, using an identification which is assigned to a second application, setting up a connection between the second application, which is executed on a second device, and the communication service, using the identification, setting up a communication channel between the first application and the second application via the communication service, and receiving, by the second application, a first message from the first application, wherein the first message designates a third application to be executed on the second device and/or a first service of the third application to be executed on the second device.

### FIELD

The present invention relates to setting up a connection between applications on different devices. In particular, the present invention relates to setting up a connection between an HbbTV application on an HbbTV device and a second application on a mobile device.

### BACKGROUND

Version 2 of the HbbTV specification defines a mechanism with which an HbbTV application (“app”) is able to find display-capable devices (e.g. tablets, mobile phones, etc.) in the local network and launch applications on the devices found. However, HbbTV-2 only describes the interface via which an HbbTV application can trigger the search for devices (“discovery”) and the launch of applications (“launch”). Therefore, manufacturer-specific protocols are typically employed for communication between the display-capable device (“second screen”) and the HbbTV device.

### PRESENTATION OF THE INVENTION

The HbbTV 2 standard provides that HbbTV device manufacturers furnish applications that implement the endpoints of a manufacturer-specific protocol on the HbbTV device and the respective display-capable device. Such manufacturer-specific launcher applications conforming to the HbbTV standard have the following weaknesses:
1. Not all manufacturers are obligated to offer a “launcher” application for their HbbTV device. This may have a negative effect on the range of corresponding services.
2. There are no binding guidelines for the user guidance of “launcher” applications with regard to installation and use as intended.
   “Launcher” applications by different manufacturers will therefore differ in these respects. This presents the providers of “second screen” applications with the challenge of informing their users which “launcher” application to be executed on the display-capable device is appropriate for the HbbTV device, where users may obtain it, and how they use it properly.

The present invention overcomes these and other problems of the methods known from the prior art for setting up a connection between applications on different devices. In this case, the present invention is not limited to HbbTV but can generally be used for setting up a connection between applications on different devices.

A method according to the invention comprises: setting up a connection between a first application on a first device and a communication service on the first device, using an identification which is assigned to a second application, setting up a connection between the second application, which is executed on a second device, and the communication service, using the identification, setting up a communication channel between the first application and the second application via the communication service, and receiving, by the second application, a first message from the first application, wherein the first message designates a third application to be executed on the second device and/or a first service of the third application to be executed on the second device.

In this case, the phrase “setting up a connection”, as it is used in the context of the present description and the claims, is to be understood, in particular, to denote the sending and receiving of messages by means of which usage data can be transmitted from one application on one device to an application on another device. Further, the term “application”, as it is used in the context of the present description and the claims, is to be understood, in particular, to denote a software program that adds to a device hitherto unavailable services and thus expands the possibilities of using the device. For example, the software program may be especially designed for execution on the operating system of the terminal device (e.g. a “native” Android or iOS application). However, the software program may also be designed in such a way that it is interpreted and executed by other applications (e.g. a web page that contains HTML, CSS and/or JavaScript code and is executed by a web browser or an application containing a web browser).

In this context, the term “device”, as it is used in the context of the present description and the claims, is to be understood, in particular, to denote an interconnection of electrical and electronic components within a functional unit, wherein the electrical and electronic components may be provided with a component-related software layer enabling the installation of an operating system on different devices.

In addition, the term “communication service”, as it is used in the context of the present description and the claims, is to be understood, in particular, to denote a service which is provided on the device by a software layer and which contributes to enabling a transmission of messages from one device to another device. In this context, the term “communication channel”, as it is used in the context of the present description and the claims, is to be understood, in particular, to denote a transmission link via which messages can be transmitted from one application on one device to an application of another device. Moreover, the term “identification”, as it is used in the context of the present description and the claims, is to be understood, in particular, to denote information which can be played back digitally and by means of which a unique assignment of entities is possible (e.g. a type of application or an instance of an application).

Preferably, the first device is configured for playing back image and sound data. For example, the first device may be configured as a television device.

Preferably, the first device is configured as an HbbTV-capable receiving device. For example, the first device may be configured as an HbbTV-capable television device.

Preferably, the first application on the first device is assigned to a first broadcasting channel, and is automatically launched or can be manually launched when the first device plays back image and sound data of the first broadcasting channel. For example, the first application may be issued by a broadcasting station and provide information and services concerning a broadcasting channel of the broadcasting station and/or interactive elements pertaining to the broadcasting channel.

Preferably, the second application verifies whether the first application is authorized to initiate the execution of the third application and/or the first service, and causes an execution of the third application and/or the first service if the first application is authorized to initiate the execution of the third application and/or the first service.

Preferably, the method further comprises: terminating the first application and executing a fourth application on the first device, setting up a communication channel between the fourth application and the second application via the communication service, using the identification, and receiving, by the second application, a second message from the fourth application, wherein the second message designates a fifth application to be executed on the second device and/or a second service of the fifth application to be executed on the second device.

The termination of the first application and the execution of the fourth application on the first device may result, for example, from a switch between a first and a second broadcasting channel and lead to other applications and/or services being launched on the second device in order to take account of the switching process and the accompanying shift of the attention of the user toward the second broadcasting channel.

The invention may further comprise the distribution of a third message by the second application executed on the second device, and a replying, by the first device, to the third message, wherein the reply includes the address of the communication service on the first device.

I.e., the second application is able to search for the first device in a network, wherein the search is completed when the first device replies with the address of the communication service on the first device.

The second application executed on the second device may be configured to repeat a set-up attempt with regard to the communication channel until the communication channel is set up.

The communication channel between the first and the second application can be set up with both using an identification identifying an instance of the second application on the second device. As a result, identical applications executed on different devices can be differentiated from each other and thus addressed in a targeted manner.

The identification may be persistently stored on the first device by the first application, and an access to the stored identification may be limited to applications originating from the same source (e.g. the same web origin) as the first application.

For example, access to the stored identification may be limited to applications issued or made available at the same internet address by the same broadcasting station.

The second application may transmit the identification to the first application, which persistently stores it on the first device.

The identification can be provided to a fifth application, which is executed on the first device and originates from a different source than the first application, and persistently stored on the first device by the fifth application.

That is, if desired, identifications may be relayed by applications to other applications, whereby they do not have not undergo the process of searching and determining suitable devices/applications.

The first application may be configured to relay the identification to the fifth application, and the fifth application may be configured to persistently store the second identification on the first device.

The second application may transmit the identification and sources of authorized applications to a sixth application on the first device, which executes the authorized applications and supplies them with the identification, wherein the authorized applications store the identification on the first device and assign them to their source.

The identification can be derived from a user input and persistently stored by an application on the first device.

The first application on the first device may send to the second application on the second device, by means of the identification via an external communication service, a fourth message that designates the third application and/or the first service provided by the third application.

The first application on the first device may send to the second application on the second device, via an external communication service and using the identification, a fifth message that prompts the second application to set up the connection between the second application and the communication service.

The third application to be executed on the second device and/or the first service to be executed on the second device may be executed immediately or at a later point in time in response to the first message or in response to a confirmation input.

Preferably, the third application provides a user interface coordinated with the playback on the first device, wherein the coordination takes place by means of a communication channel set up between the first application and the third application.

In this case, it will be understood that the steps carried out in the context of the method can be executed by instructions persistently stored on a device, by which the device is configured to carry out the steps.

### BRIEF DESCRIPTION OF THE DRAWINGS

The invention is explained below in the detailed description based on exemplary embodiments, wherein reference is made to drawings, in which:

FIG. 1a shows a first exemplary system with a first device and a second device;

FIG. 1b shows a second exemplary system with a first device and a second device;

FIG. 1c shows a third exemplary system with a first device and a second device;

FIG. 1d shows a fourth exemplary system with a first device and a second device;

FIG. 1e shows a fifth exemplary system with a first device and a second device;

FIG. 2 shows a process for setting up a communication channel between a first application on the first device and a second application on the second device of the systems shown in FIGS. 1a, 1b, 1c and 1d;

FIG. 3 shows a modification of the process shown in FIG. 2, in which, in addition to the second application on the second device, another application on a third device signals its connection readiness;

FIG. 4 shows further steps of the process shown in FIG. 2, in which it is verified whether the first application is authorized for launching the third application or of the first service;

FIG. 5 shows further steps of the process shown in FIG. 4, in which the second applications searches for (and finds) the communication service; and

FIG. 6 shows another modification of the process shown in FIG. 2, in which the second application attempts to set up a communication channel until the communication service replies.

Here, the same or functionally similar elements are labeled in the drawings with the same reference numbers.

### MODES FOR CARRYING OUT THE INVENTION

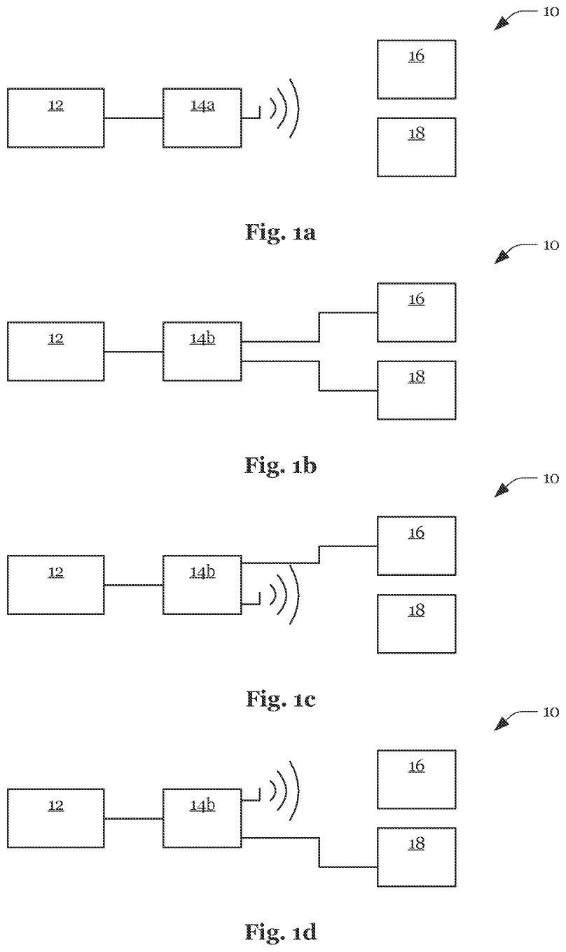

FIG. 1a shows a first system 10 comprising a first device 12, which is capable of exchanging data with a second device 16 and a third device 18 via an internal or external radio unit 14a. The first device 12 may be configured for playing back image and/or sound data. For example, the first device 12 may be a television device (e.g. an HbbTV-capable television device), which is configured for receiving one or several broadcasting channels via a radio or cable interface and for playing back the image and/or sound data contained in a selected broadcasting channel (on a screen or by means of one or several loudspeakers). The second device 16 and the third device 18 may be configured as mobile devices (e.g. as a tablet, mobile phone, etc.) and also be configured for playing back image and/or sound data (on a screen and by means of one or several loudspeakers). The devices 12, 16, 18 may be nodes of a network (e.g. of a home network set up by a WLAN-capable router 14a) and capable of being addressed in the network via addresses.

FIG. 1b shows a second system 10, which differs from the system 10 shown in FIG. 1a in that the second device 16 and the third device 18 are connected to the first device 12 not via a radio link, but via a wired transmission link (e.g. via a router 14b and an Ethernet connection). FIG. 1c shows a third system 10, which differs from the system 10 shown in FIG. 1a in that the second device 16 is connected to the first device 12 not via a radio link, but via a wired transmission link (e.g. via a router 14b and an Ethernet connection). FIG. 1d shows a fourth system 10, which differs from the system 10 shown in FIG. 1a in that the third device 18 is connected to the first device 12 not via a radio link, but via a wired transmission link (e.g. via a router 14b and an Ethernet connection).

FIG. 1e shows a fifth system 10, which differs from the systems 10 shown in FIGS. 1b to 1d in that the first device 12 is connected via radio to the router 14b, and the router 14b is also connected via radio to the second device 16 and the third device 18. In this case, the second device 16 and/or the third device 18 may also, of course, be connected to the router 14b via a wired transmission link.

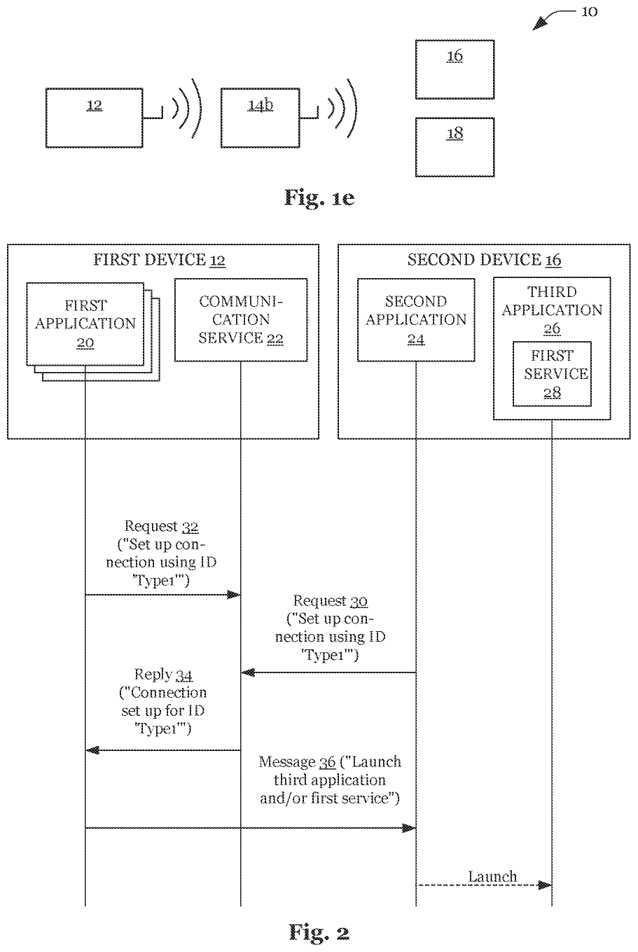

FIG. 2 shows a process for setting up a communication channel between the first device 12 and the second device 16. Here, it is assumed that the identification ID of the first application 20 is available in the form of a type identifier “Type” (e.g. “Name of a launcher app implementation”). The session shown in FIG. 2 starts with the first application 20 (e.g. an HbbTV application) opening up a connection to a communication service 22 (e.g. an APP2APP local endpoint) (appending, for example, the ID to the corresponding URL).

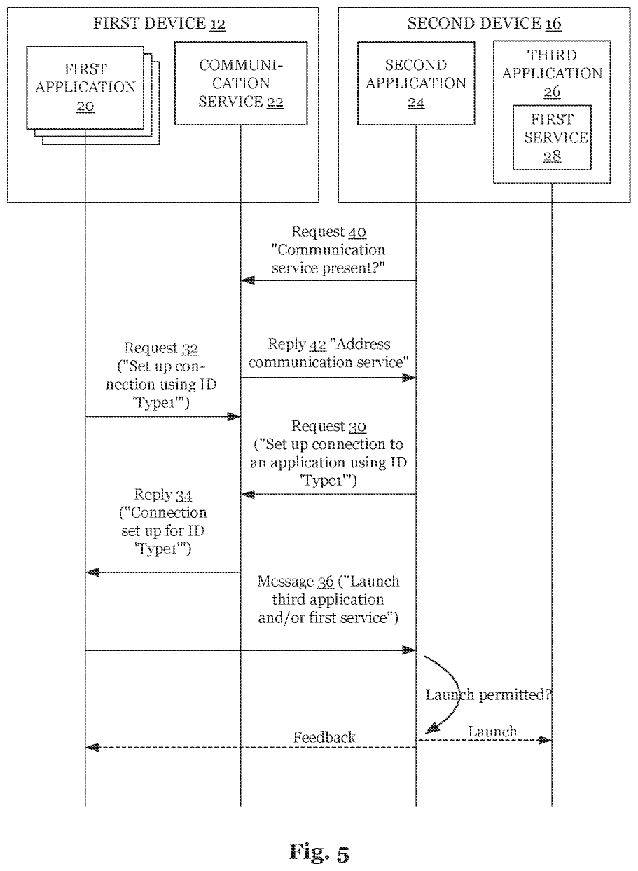

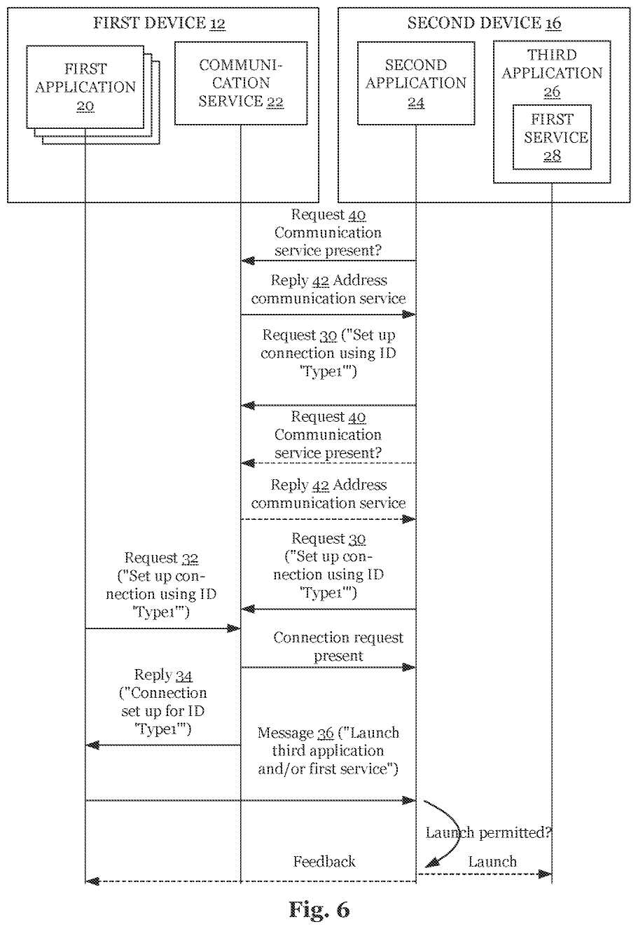

As shown in FIGS. 5 and 6, the sequence shown in FIG. 2 may have already been preceded by attempts by the second application 24 to find the communication service 22 (or the APP2APP remote endpoint) and connect with it. For example, the second application 24 may perform a communication service discovery routine (e.g. by means of the “discovery” routine described in HbbTV-2), by means of which it finds the communication service 22 (e.g. the APP2APP remote endpoint). In this case, the communication service 22 may be always available, or only for as long as the first application 20 keeps the connection with the communication service 22 open. For example, an APP2APP remote URL of an APP2APP remote endpoint in accordance with the HbbTV-2 specification may be capable of being reached only after opening by an HbbTV application and only until the HbbTV application closes the connection to the communication service 22. Thus, connection attempts may fail because no application has connected with the corresponding remote station (or the APP2APP local endpoint). It is also possible that a previously existing connection was interrupted because an application with which a connection existed was terminated.

After the second application 24 has found the communication service 22 (or the APP2APP remote endpoint), it can set up a connection with it, as illustrated in FIG. 2, wherein it appends the ID (which is assigned to the second application) to the APP2APP remote URL, for example, and sends a corresponding request 30 to the communication service 22. If the IDs specified by the first application 20 in the request 32 and the second application in the request 30 match, the communication service 22 on the first device 12 sets up a connection between the two applications 20, 24. The communication service 22 can notify the first application 20 and/or the second application 24 of the setting up of the connection by means of a message 34 (“pairingcompleted”). The first application 20 can now, via the communication service 22, request from the second application 24 the launch of a third application 26 and/or a first service 28 on the second device 16 (e.g. a “second screen”) with a corresponding message 36.

The second application 24 may be configured to allow applications 20 (e.g. different HbbTV applications) by different providers or applications 20 from different sources on the first device 12 to launch applications/services on the second device 16. In order for an application 20 on the first device 12 to be able to connect with the second application 24, the respective application 20 requires knowledge of an ID, which may be, for example, a type and/or instance identifier of the second application 24. In this case, it may be provided that the ID stored by a certain application 20 on the first device 12 may only be read by applications 20 originating from the same source (or were downloaded from the same source). In this context, a source may be defined, for example, by a communication protocol (e.g. http or https), a host (e.g. www.irt.de) and a port (e.g. 80) via which the application can be downloaded, wherein the applications 20 by different publishers are generally obtained from different sources. However, a publisher may also offer applications 20 via different sources.

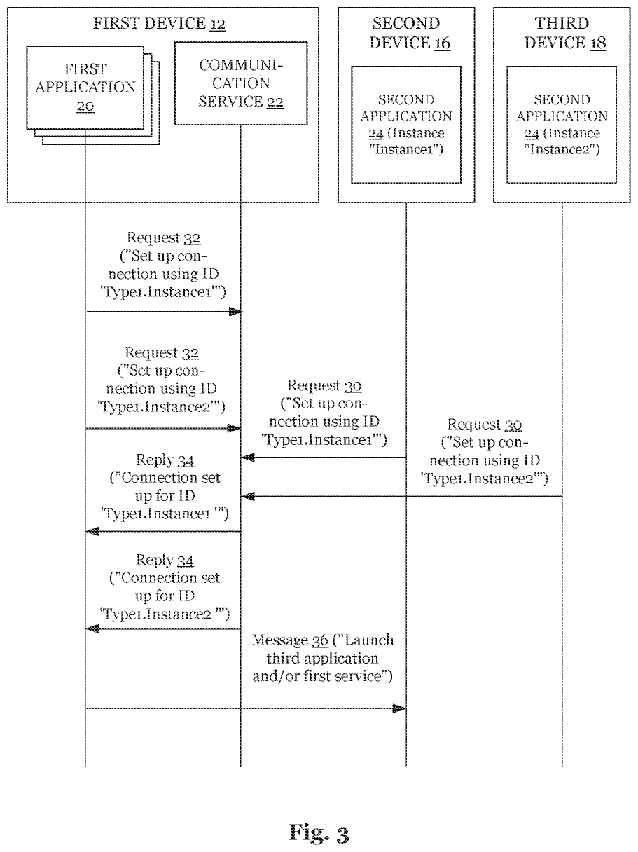

As shown in FIG. 3, applications 24 of the same type that can be executed on different devices (e.g. on the second device 16 and the third device 18) can be distinguished from each other due to the fact that, when carrying out the request 30, they (explicitly or implicitly) transmit the ID with which the instances can be distinguished from each other. The ID may be transmitted to one or several first applications 20 (from different sources) on the first device 12 within the framework of an installation routine. The one or the several applications 20 may persistently store the ID on the first device 12. The installation routine may be configured such that the user is able to define which applications 20 (or which applications 20 from which sources) are later allowed to connect with an application 24 of a certain type.

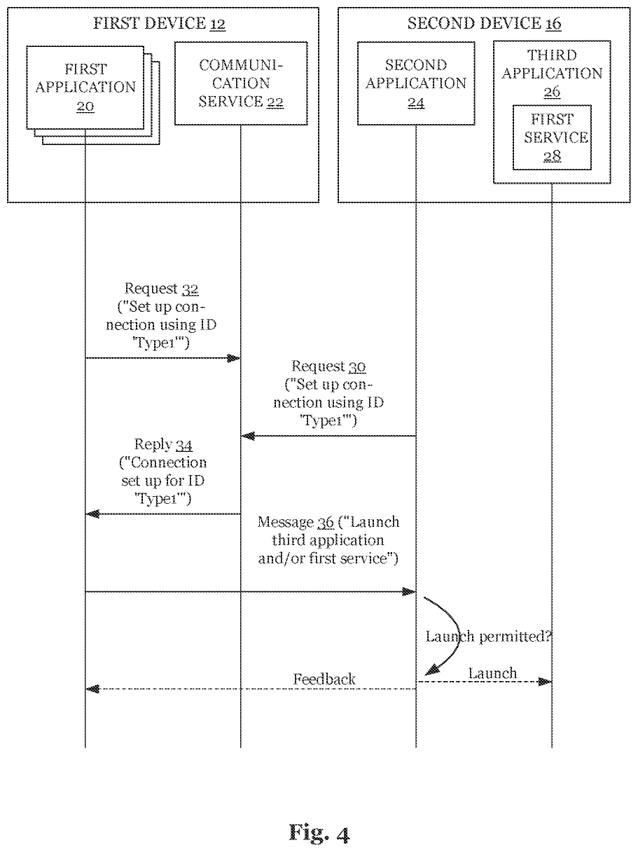

As is illustrated in FIG. 4, the first application 20 may add information (e.g. the type of application of the first application 20), which identifies the first application 20, to the message 36 regarding the third application 26 to be launched or the first service 28 to be launched. Based on the information, the second application 24 is able to verify whether the first application 20 is authorized, in general, to launch any applications/services, or especially to launch the third application 26 and/or the second service 28. For example, the second application 24 may compare the information to a “blacklist” (list of applications/services for which the launch is prohibited) or a “whitelist” (list of applications/services for which the launch is permitted).

If the first application 20 does not appear in any list, the second application 24 may prompt the user to indicate whether he consents to this (and future) launches of applications and/or services by the first application 20. If the first application 20 is authorized to launch the respective application and/or the respective service, the second application 24 may notify the first application 20 of this and then attempt to launch the requested application or the requested service. If the first application 20 is not authorized, the second application 24 may also notify the first application 20 of this. In this case, the second application may provide 24 details as to the reasons, e.g. that the first application 20 is included in a “blacklist”. This allows the first application 20 to display corresponding notices to the user.

In the HbbTV segment, the above-described solution offers an alternative for the manufacturer-specific “launcher” applications specified in HbbTV-2. It permits the “launch” of applications/services on “second screens” across TV services and in the process requires no additional web server. The latter is advantageous in that the operating costs are not increased as the number of users rises. In addition, no data have to be stored outside the second application 24, with the exception of the ID on the first device 12. A user profile, which contains a history of launched applications/services and a list of favorites with applications/services managed by the user, for example, may be stored in the second application 24 on the second device 16. Thus, the user has full and sole sovereignty over their data and is the only one capable of reading, deleting and changing them.

In order to avoid the user having to input the ID for each application 20 (that is supposed to be able to connect with the second application 24) individually, a list of these applications 20 may be stored in the second application 24, and the second application 24 may be configured to address the applications 20 on the first device 12 one after the other and notify them of the ID in the process.

In the case of HbbTV applications, the discovery and launch protocols from HbbTV-2, for example, may be used for this purpose. For example, the second application 24 may transmit the ID via the communication service, or already as a parameter in the start URL, to the applications 20 on the first device 12, which may persistently store them on the first device 12 (e.g. in a cookie). The ID is then available for future connections. The list of applications 20 on the first device 12 that (possibly) require the ID may be updated in “updates” of the second application 24. After the update, another setup (with a sequential addressing of the applications 20 on the first device 12) may be carried out.

For example, the second application 24 may launch an application 20 from a certain source on the first device 12 (for example, via the DIAL protocol from the HbbTV specification in an HbbTV environment) and transmit the ID in the process. The application 20 from the source may store the ID and relay it to an application 20 from a further source. The application 20 from the further source may also store the ID and, in turn, relay it to an application 20 from another source, etc.

Where the applications 20 are supposed to relay the ID may be defined in different ways. For example, an application 20 from a certain source may be provided with a list of further applications 20 to which the ID is supposed to be relayed, and during the relaying process, the list may be handed over, together with the ID, to the first application 20 on the list. The first application 20 on the list may then be removed from the list, and the list may be handed over, together with the ID, to the next application 20 on the list, etc.

Moreover, the first application 20 may set up a connection with the second application 24 and notify the second application 24 that it has stored the ID. Then, the second application 24 may send a command to the first application 20 to relay the ID to another application 20 from another source, which then sets up a connection with the second application 24, etc.

Furthermore, the second application 24 may launch (e.g. in an HbbTV environment by means of the DIAL protocol from the HbbTV-2 specification) all application 20 from the authorized source one after the other and in each case transmit the ID in the process.

Moreover, the second application 24 may launch an application on the first device 12 and transmit in each case the URLs of all applications 20 from authorized sources. The launched application may then incorporate the applications 20 from the authorized sources as inline frames and hand over the ID to the applications 20 in the inline frames. For example, the ID may be handed over to the addresses of the applications 20 from authorized sources by means of URL parameters. Moreover, the ID may be transported between the launched application and the authorized applications 20 by means of the W3C web messaging API, by being embedded into inline frames.

In addition, a web service may be used. In the event an application 20 on the first device 12 wants to connect to the second application 24, and the ID is not provided, the application 20 may configure a relay to the application of the web service. If the ID is not available to the application of the web service, it may prompt the user to input the ID. If the user has inputted the ID, the application of the web service may store it on the first device 12. Then, the application of the web service may install forwarding to the application 20 on the first device 12 and transmit the ID in the process. The application 20 on the first device 12 may store the ID on the first device 12. Thus, the ID can be made available to all applications 20 on the first device 12 by means of a relay to the application of the web service.

Moreover, on second devices 16 with Android and iOS operating systems, the web service may serve as a central gateway to Google's “Firebase Cloud Messaging” service (other platforms for second devices 16 offer equivalent services). Applications 24 that run in the background on a device 16 and do not have special privileges are typically cleaned up by the operating system after a certain time, in order to free up resources such as working memory and CPU. In this state, said applications 24 are no longer able to execute any code. In the cleaned-up state, the second application 24 could no longer search for the first device 12 or the communication service 22 in the network (home network) or respond to messages from a first application 20. Besides the user restarting the second application 24, scheduled tasks (e.g. “JobScheduler” under Android) and “Firebase Cloud Messages” (FCM) may be used in order to render the second application 24 capable of acting again. FCMs are push notifications that can be sent via the Firebase Cloud Messaging service to an application on a device 16.

In response to an FCM, the application 24 may display a notification (e.g. a “notification” as an “icon” in the status bar, optionally supported by a vibration alert and/or a signal tone) to the operator, via which the user can then launch the second application 24 again. Under Android, it is also possible to launch the application 24 by means of FCM as a so-called “foreground” service. This is a service that runs in the background on a device 16 but is visible to the user in the process, e.g. by an icon in the status bar. In combination with FCM, the web service offers to applications 20 on a first device 12 the possibility of triggering actions in non-reachable second applications 24 on a second device 16 that make them capable of being reached again.

### LIST OF REFERENCE NUMERALS

10 System
12 First device
14a Radio unit
14b Router
16 Second device
18 Third device
20 First application
22 Communication service
24 Second application
26 Third application
28 First service
30 Message
32 Message
34 Message
36 Message
40 Message
42 Message

1. A method comprising:
setting up a connection between a first application on a first device and a communication service on the first device, using an identification which is assigned to a second application;
setting up a connection between the second application, which is executed on a second device, and the communication service, using the identification;
setting up a communication channel between the first application and the second application via the communication service; and
receiving, by the second application, a first message from the first application, wherein the first message designates a third application to be executed on the second device and/or a first service of the third application to be executed on the second device.

2. The method according to claim 1, wherein the first device is configured for playing back image and sound data.

3. The method according to claim 2, wherein the first device is configured as an HbbTV-capable receiving device.

4. The method according to claim 2, wherein the first application on the first device is assigned to a first broadcasting channel, and is automatically launched or can be manually launched when the first device plays back image and sound data of the first broadcasting channel.

5. The method according to claim 1, wherein the second application verifies whether the first application is authorized to initiate the execution of the third application and/or the first service, and causes an execution of the third application and/or the first service if the first application is authorized to initiate the execution of the third application and/or the first service.

6. The method according to claim 1, further comprising:
terminating the first application and executing a fourth application on the first device;
setting up a communication channel between the fourth application and the second application via the communication service, using the identification; and
receiving, by the second application, a second message from the fourth application, wherein the second message designates a fifth application to be executed on the second device and/or a second service of the fifth application to be executed on the second device.

7. The method according to claim 1, further comprising:
distributing a third message by the second application executed on the second device; and
replying, by the first device, to the third message, wherein the reply includes the address of the communication service on the first device.

8. The method according to claim 1, wherein the second application executed on the second device repeats a set-up attempt with regard to the communication channel until the communication channel is set up.

9. The method according to claim 1, wherein the identification is assigned to an instance of the second application on the second device.

10. The method according to claim 9, wherein the identification is persistently stored on the first device by the first application and an access to the stored identification is limited to applications originating from the same source as the first application.

11. The method according to claim 9, wherein the second application transmits the identification to the first application, which persistently stores it on the first device.

12. The method according to claim 11, wherein the identification is provided to a fifth application, which is executed on the first device and originates from a different source than the first application, and is persistently stored on the first device by the fifth application.

13. The method according to claim 12, wherein the first application relays the identification to the fifth application, and the fifth application persistently stores the identification on the first device.

14. The method according to claim 9, wherein the second application transmits the identification and sources of further applications to a sixth application on the first device, which executes the further applications and supplies them with the identification, wherein the further applications store the identification on the first device and assign them to their source.

15. The method according to claim 9, wherein the identification is derived from a user input and persistently stored by an application on the first device.

16. The method according to claim 9, wherein the first application on the first device sends to the second application on the second device, by means of the identification via an external communication service, a fourth message that designates the third application and/or the first service provided by the third application.

17. The method according to claim 9, wherein the first application on the first device sends to the second application on the second device, via an external communication service and using the identification, a fifth message that prompts the second application to set up the connection between the second application and the communication service.

18. The method according to claim 1, wherein the third application to be executed on the second device and/or the first service to be executed on the second device are executed immediately or at a later point in time in response to the first message or in response to a confirmation input.

19. The method according to claim 1, wherein the third application provides a user interface coordinated with the playback on the first device, wherein the coordination takes place by means of a communication channel set up between the first application and the third application.
